(19) United States
(12) Patent Application Publication
(10) Pub. No.: US 2005/0227898 A1
(43) Pub. Date: Oct. 13, 2005

(54) Zero to low VOC glass and general purpose cleaner

(76) Inventors: James J. Leskowicz, Racine, WI (US); Loretta G. Lynch, Racine, WI (US); Jacqueline V. Lepow, Franklin, WI (US)

Correspondence Address: S.C. JOHNSON & SON, INC., 1525 HOWE STREET, RACINE, WI, 53403-2236, US

(21) Appl. No.: 10/822,301

(22) Filed: Apr. 9, 2004

(51) Int. Cl. C11D 17/00

(52) U.S. Cl. 510/407

(57) ABSTRACT

A glass and general purpose cleaning composition is described which has zero to low volatility while providing acceptable cleaning and drying rates. The cleaning composition contains at least one low-volatile non-VOC evaporative organic solvent, at least one surfactant, an aqueous carrier and, optionally one or more co-solvents. The composition has less than about 4% by wt. volatile organic solvent compound (VOC) content.

### FIELD OF INVENTION

The present invention relates to compositions for cleaning hard surfaces, including glass surfaces. The compositions contain from zero to low amounts only of one or more volatile organic compounds (VOCs).

### BACKGROUND OF THE INVENTION

Glass and general purpose cleaning compositions desirably have good cleaning characteristics which include good detergency, evaporatability, and no streaking or hazing. Typically, glass and general purpose cleaners depend on the usage of a combination of alcohols, high-volatile glycol ethers, low-volatile glycol ethers, and surfactants to obtain cleaning and acceptable drying rates. Alcohols and high-volatile glycol ethers, such as used in conventional formulas, are classified as VOCs while low-volatile glycol ethers and surfactants, as useful in the present invention, are classified as non-VOCs. Thus, non-VOC solvents are termed low-volatile non-VOC solvents. While to date, existing environmental government regulations allow glass and general purpose cleaners to have a maximum of 6% VOCs in a formulation, significantly lower VOC levels are desirable as evident by California's regulatory change to only allow a maximum of 4% VOCs in such formulations after Dec. 31, 2004. Lower or zero VOC levels would be beneficial to the environment as well as result in significant cost savings since use of volatile organic compounds tend to increase expense. The problem has been to provide a cleaning composition with no or low volatility while retaining acceptable cleaning and drying rates.

### SUMMARY OF THE INVENTION

Accordingly, a primary object of the present invention is to provide a glass and general purpose cleaning composition which has zero to low volatile organic compound (VOC) content while having acceptable cleaning and drying rates.

A further primary object is to provide a cleaning composition which delivers the attributes of streak-free cleaning and acceptable drying rates while containing from zero to low, i.e., 0 to about 4% by wt., of VOCs.

A further primary object is to provide a glass and general purpose cleaning composition which provides acceptable cleaning and drying rates in the absence of volatile organic compounds, in particular alcohols.

The glass and general purpose cleaning composition of the invention has from greater than 0 to about 30% by weight of at least one low-volatile non-VOC organic compound as an evaporative solvent and from 0 to about 4% by weight of one or more VOC solvents. The solvents serve to provide both cleaning and acceptable drying rates.

The cleaning composition of the invention includes an aqueous carrier, one or more low-volatile non-VOC organic evaporative solvents, one or more surfactants, optionally one or more co-solvents, and optionally one or more adjuvants such as pH adjusting agent(s), colorant(s), fragrance(s), coalescent(s) and the like. Preferably the components are included in ranges of about greater than 0 to about 20% by wt. of the one or more low-volatile non-VOC evaporative solvents, about greater than 0 to about 10% by wt. of the one or more surfactants, about 50 to about 99.9% by wt. of the aqueous carrier, from 0 to about 30% by weight of one or more co-solvents and from 0 to about 5% by wt. of one or more adjuvants which would include generally about 0 to about 0.5% by wt. colorant, about 0 to about 1% by wt. fragrance, about 0 to about 2% by wt. coalescent, and sufficient pH adjusting agent(s) to provide a pH of about 2 to about 13 in the composition.

The cleaning composition of the invention is useful as a general surface cleaner, anti-bacterial cleaner, low VOC degreaser, soap scum remover, floor cleaner, and the like. The cleaning composition can be dispensed by conventional means, such as in liquid, spray, aerosol or gel form, either as a concentrate or in a ready to use dilute form. As a concentrate, the composition can be diluted on use, e.g. by mixture with water in a bucket or by hose-end application.

### DETAILED DESCRIPTION OF PRESENTLY PREFERRED EMBODIMENTS

The glass and general purpose cleaning composition of the invention has zero to low volatility based on the use of at least one low-volatile non-VOC evaporative solvent, such as low-volatile non-VOC glycol ether(s), in combination with one or more surfactants serving as cleaning agents, and an aqueous carrier and, optionally, at least one co-solvent different from the low-volatile non-VOC evaporative solvent.

The low volatile non-VOC evaporative solvents useful in the invention have limited solubility in water of less than 20% and reduce surface tension of the composition to less than 40 dynes/cm. The surfactant is preferably low-streaking and can be amphoteric, anionic, nonionic, cationic or a mixture thereof. The surfactant(s) and optional co-solvent(s) provide for good solubilization of the other components present in the composition in addition to acting as a cleaning agent. The cleaning composition of the invention has a VOC content of from 0 to about 4% by wt., preferably from about 0 to about 1% by wt., more preferably from about 0 to about 0.5% by wt., and most preferably about 0% by wt.

The low-volatile non-VOC evaporative solvent(s) is(are) preferably non-VOC glycol ethers. Such provide for streak-free cleaning. Non-VOC glycol ethers suitable for use in the composition of the invention include those having a formula as follows:
R₁—O—R₂
wherein R₁ is a C₁-C₈ linear, branched or cyclic alkyl or alkenyl, optionally substituted with —OH, —OCH₃, or —OCH₂CH₃; and R₂ is a C₁-C₆ linear, branched or cyclic alkyl or alkenyl substituted with —OH.

Preferably, R₁ is an optionally substituted C₃-C₆ alkyl or alkenyl, and R₂ is a monosubstituted C₂-C₄ linear or branched alkyl or alkenyl.

More preferably, R₁ is an unsubstituted or monosubstituted linear or branched C₃-C₆ alkyl, and R₂ is a monosubstituted C₂-C₄ linear or branched alkyl.

Most preferably, R₁ is an unsubstituted n-C₃-C₄ or n-C₆ linear alkyl or

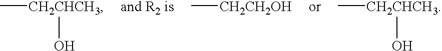

Suitable non-VOC glycol ethers include tripropylene glycol n-propyl ether, ethylene glycol n-hexyl ether, diethylene glycol n-hexyl ether, dipropylene glycol n-butyl ether, tripropylene glycol n-butyl ether and propylene glycol phenyl ether.

The preferred non-VOC glycol ether for inclusion in the cleaning composition is ethylene glycol n-hexyl ether, also known as hexyl cellosolve.

Other compounds suitable for use as the low-volatile non-VOC evaporative solvent include, but are not limited to, non-VOC glycol ethers, esters, polyhydric alcohols, amines, or other organic compounds with limited solubility in water, i.e., less than 20%, and serve to reduce surface tension of the aqueous composition to less than 40 dynes/cm. These solvents serve generally to provide cleaning of most oils, grease and dirt.

Specific additional examples of the non-VOC evaporative solvents which are suitable for use include: (1) esters such as diethylene glycol monobutyl ether acetate; (2) polyhydric alcohols such as 2-ethyl-1,3-hexanediol(octanediol), diethylene glycol; and (3) amines with limited solubility in water, i.e., less than 20%, and serve to reduce the surface tension of the aqueous composition to less than 40 dynes/cm.

The low-volatile non-VOC evaporative solvent is preferably present in an amount in a range of about 0.1 to about 20% by wt., more preferably about 0.1 to about 5% by wt. and most preferably about 0.1 to about 1% by wt.

Other solvents in addition to the low-volatile non-VOC evaporative solvent may be included in the cleaning composition of the invention. Co-solvents suitable for use include non-VOC and VOC-type glycol ethers, aliphatic and polyhydric alcohols, ketones, acids, and amines. The co-solvent(s) may be partially or fully soluble in water. Such co-solvents serve to control drying and application properties. These co-solvents can also provide additional cleaning of most oils, grease and dirt. When the co-solvent is a low volatile non-VOC solvent, such solvent has either a different water solubility or different tension reduction capacity as compared to the low volatile non-VOC evaporative solvent.

Specific examples of co-solvents different from the low-volatile non-VOC evaporative glycol ether solvents described above which are also suitable for use include (1) non-VOC and VOC glycols and glycol ethers such as tripropylene glycol methyl ether, diethylene glycol n-butyl ether, triethylene glycol methyl ether, triethylene glycol ethyl ether, triethylene glycol n-butyl ether, ethylene glycol n-butyl ether, dipropylene glycol methyl ether, propylene glycol n-butyl ether, and propylene glycol n-propyl ether; (2) non-VOC and VOC esters such as methyl acetate, ethyl acetate, dipropylene glycol methyl ether acetate; (3) non VOC and VOC aliphatic and polyhydric alcohols such as, isopropanol, propylene glycol, 1,3-butanediol, hexylene glycol; (4) non-VOC and VOC ketones such as acetone, methyl ethyl ketone, cyclohexanone, diacetone alcohol; (5) non-VOC and VOC acids such as acetic acid, lactic acid, trifluor-acetic acid, 2-ethylbutyric acid; and (6) non-VOC and VOC amines such as alkanolamines, e.g. monoethanolamine, diethanolamine, triethanolamine, n-amylamine, diethyl-amine; and combinations thereof.

Such co-solvents are preferably present in an amount of from 0 to about 30% by wt., more preferably about 0 to about 5% by wt., and most preferably about 0 to about 1% by wt. of the cleaning composition. Necessarily if a VOC compound is used as a co-solvent, such compound is present in an amount so that the composition has less than about 4% by weight VOC content.

One or more surfactants can be present in the composition of the invention to provide cleaning and solubilization of the other components present in the composition. The surfactant(s) can be amphoteric, anionic, nonionic, cationic or a mixture thereof. Preferably such surfactants are selected from low streaking surfactant compounds. The one or more surfactants are present in an amount in a range of about 0 to about 10% by wt., more preferably about 0 to about 3% by wt., and most preferably about 0 to about 0.6% by wt.

Amphoteric surfactants suitable for use include, for example, betaines, alkyl imidazolines, cocoamphopropionates, or combinations thereof.

A preferred amphoteric surfactant is disodium cocoamphodipropionate (also known as cocoimidazoline carboxylate) such as sold under the tradename MACKAM 2CSF. When an amphoteric surfactant is utilized, the amphoteric surfactant is preferably used under alkaline conditions to render the anionic portion of the amphoteric compound active.

Suitable anionic surfactants for use include alkyl sulfates, alkyl benzene sulfonates, α-olefin sulfonates, alkyl taurates, alkyl sacrosinates, alkyl diphenyloxide disulfonates, alkyl naphthalene sulfonates, alkyl ether sulfates, alkyl ether sulfonates, sulfosuccinates, and other anionic surfactants as known for use in cleaning compositions. The surfactants are typically available as the alkali metal, alkaline earth and ammonium salts thereof. Preferred anionic surfactants are linear C₈₋₁₆ alkyl sulfates, C₈₋₁₆ alkyl sulfonates, C₈₋₁₆ alkyl benzene sulfonates and C₈₋₁₆ alkyl diphenyloxide disulfonates. Most preferred anionic surfactants for use in the composition of the invention are decyl sulphophenoxy benzene/oxybis decyl benzene sulfonic acid disodium salt (such as sold under the tradename DOWFAX C10L surfactant), and sodium octane sulfonate, sodium dodecyl sulfonate, and sodium lauryl sulfate.

Suitable nonionic surfactants for use in the cleaning composition include alkoxylated alcohols, alkoxylated ether phenols, silicone-based compounds such as silicone glycol copolymers, and semi-polar nonionics such as trialkyl amine oxides. Preferred nonionics are ethoxylated (EO) and/or propoxylated (PO) alcohols, such as EO and/or PO C₆₋₁₆ alcohols with about 2-10 moles of EO or PO, or 1-10 moles EO and 1-10 moles PO, per mole of alcohol; or EO, PO and EO/PO alkyl phenols.

Cationic surfactants are also available for inclusion, both for cleaning ability and, upon suitable selection, anti-bacterial/germicidal characteristics, e.g. quaternary ammonium compounds. Examples of useful cationic surfactants include N-alkyl trimethyl ammonium chloride, and dimethyl dicoco quaternary ammonium chloride.

The aqueous carrier is preferably water in an amount of about 30 to about 99.5% by wt., more preferably about 90 to about 99.5% by wt. and most preferably about 95 to about 99.5% by wt.

An additional component which can advantageously be present in the zero to low VOC glass or general purpose cleaners of the invention is a polymer or copolymer, most notably an acrylic polymer or copolymer. The presence of an acrylic (co)polymer in the formulas of the invention have been found to provide water-sheeting properties to the surfaces cleaned with the formulas of the invention containing the acrylic (co)polymer. An example of an acrylic copolymer suitable for use is POLYQUART AMPHO 149 as sold by Cognis Corporation. POLYQUART AMPHO 149 (CASR-No. 192003-74-0) is the sodium salt of the polymer with ethyl 2-propenoate and N,N,N-trimethyl-3-((2-methyl-1-oxo-2-propenyl)amino)-1-propanaminium chloride.

One or more adjuvants can be present to enhance the cleaning and/or aesthetic qualities of the cleaning composition. Suitable adjuvants include pH adjusting agents, hydrotropes, fragrances, dyes or colorants, preservatives, anti-bacterial agents, thickeners, and the like as known for use in cleaning compositions. Adjuvants are typically present in low amounts, e.g. below about 5% by wt. Suitable agents to adjust pH include conventional acids, bases, and salts thereof, such as C₂₋₄ alkanolamines, ammonia, alkali metal hydroxides, silicates, borates, carbonates, bicarbonates, citrates, citric acid, or mixtures thereof.

Preferred examples of pH adjusting agents include ammonium hydroxide and monoethanolamine. Monoethanolamine can also provide cleaning. The cleaning composition of the invention preferably has a pH in the range of 2 or above, more preferably in the range of about 9 to about 13, and most preferably about 10 to about 11.5. The pH adjusting agent is added in an amount appropriate to reach the desired pH.

### EXAMPLES

The following examples are provided as illustrative of the present invention of a glass and general purpose cleaning composition.

| | |
|---|---|
| Ingredients | % by wt. |

Example 1

| | |
|---|---|
| Soft Water | 98.1926 |
| Colorant | 0.0074 |
| Hexyl Cellosolve | 0.60 |
| Ammonium Hydroxide (28-30%) | 0.30 |
| Propylene Glycol | 0.25 |
| Monoethanolamine | 0.20 |
| MACKAM 2CSF | 0.40 |
| Fragrance | 0.05 |
| VOC Content = 0.2% | 100% |

Example 2

| | |
|---|---|
| Soft Water | 98.0426 |
| Hexyl Cellosolve | 0.60 |
| Ammonium Hydroxide (28-30%) | 0.30 |
| Propylene Glycol | 0.25 |
| Monoethanolamine | 0.20 |
| MACKAM 2CSF | 0.40 |
| Colorant | 0.0074 |
| Fragrance | 0.05 |
| DOWFAX C10L Surfactant | 0.15 |
| VOC Content = 0.2% | 100% |

Example 3

| | |
|---|---|
| Soft Water | 97.9926 |
| Hexyl Cellosolve | 0.60 |
| Ammonium Hydroxide (28-30%) | 0.30 |
| Propylene Glycol | 0.25 |
| Monoethanolamine | 0.40 |
| MACKAM 2CSF | 0.40 |
| Colorant | 0.0074 |
| Fragrance | 0.05 |
| VOC Content = 0.4% | 100% |

Example 4

| | |
|---|---|
| Soft Water | 97.5926 |
| Hexyl Cellosolve | 0.60 |
| Ammonium Hydroxide (28-30%) | 0.30 |
| Propylene Glycol | 0.25 |
| Monoethanolamine | 0.40 |
| MACKAM 2CSF | 0.40 |
| Colorant | 0.0074 |
| Fragrance | 0.05 |
| Anionic Surfactant* | 0.40 |
| VOC Content = 0.4% | 100% |

*Sodium octane sulfonate or sodium dodecylbenzene sulfonate, or sodium
lauryl sulfate.

Example 5

| | |
|---|---|
| Soft Water | 94.4426 |
| Hexyl Cellosolve | 0.60 |
| Isopropanol, anhydrous | 3.00 |
| MACKAM 2CSF | 0.60 |
| DOWFAX C10L Surfactant | 0.15 |
| Monoethanolamine | 0.60 |
| Propylene Glycol | 0.25 |
| Ammonium Hydroxide | 0.30 |
| Fragrance | 0.05 |
| Colorant | 0.0074 |
| VOC Content = 3.6% | 100% |

Example 6

| | |
|---|---|
| Soft Water | 94.2426 |
| Hexyl Cellosolve | 0.60 |
| Isopropanol, anhydrous | 3.00 |
| MACKAM 2CSF | 0.60 |
| DOWFAX C10L Surfactant | 0.15 |
| POLYQUART AMPHO 149* | 0.20 |
| Monoethanolamine | 0.60 |
| Propylene Glycol | 0.25 |
| Ammonium Hydroxide | 0.30 |
| Fragrance | 0.05 |
| Colorant | 0.0074 |
| VOC Content = 3.6% | 100% |

*Aqueous solution of an acrylic copolymer.

Example 7

| | |
|---|---|
| Soft Water | 96.1426 |
| Hexyl Cellosolve | 0.60 |
| Isopropanol, anhydrous | 1.50 |
| MACKAM 2CSF | 0.30 |
| DOWFAX C10L Surfactant | 0.15 |
| Sodium Dodecyl Benzene Sulfonate | 0.15 |
| Monoethanolamine | 0.40 |
| Sodium Octane Sulfonate | 0.15 |
| Propylene Glycol | 0.25 |
| Ammonium Hydroxide | 0.30 |
| Fragrance | 0.05 |
| Colorant | 0.0074 |
| VOC Content = 1.9% | 100% |

As will be apparent to one skilled in the art, various modifications can be made within the scope of the aforesaid description. Such modifications being within the ability of one skilled in the art form a part of the present invention and are embraced by the appended claims.

1. A hard surface cleaning composition comprising
(a) an effective amount of at least one low-volatile non-VOC evaporative organic solvent that has limited solubility in water of less than 20% and reduces surface tension of the composition to less than 40 dynes/cm;
(b) an effective amount of at least one surfactant which is amphoteric, anionic, nonionic, cationic, or a mixture thereof,
(c) optionally an effective amount of at least one co-solvent which is different from (a) and when said co-solvent is a low volatile non-VOC solvent, said co-solvent has at least a different water-solubility or different surface tension reduction capacity from said solvent of (a); and
(d) an aqueous carrier;
wherein said composition has less than about 4% by wt. volatile organic compound (VOC) content.

2. A hard surface cleaning composition comprising
(a) greater than 0 to about 4% by wt. of at least one low-volatile and/or high-volatile evaporative organic solvent that has limited solubility in water of less than 20% and reduces surface tension of the composition to less than 40 dynes/cm;
(b) greater than 0 to about 5% by wt. of at least one surfactant which is amphoteric, anionic, nonionic, cationic or a mixture thereof;
(c) from 0 to about 30% by wt. of at least one co-solvent which is different from (a) and when said co-solvent is a low volatile non-VOC solvent, said co-solvent has at least a different water-solubility or different surface tension reduction capacity from said solvent of (a); and
(d) a balance of an aqueous carrier;
wherein said composition has less than about 4% by wt. volatile organic compound (VOC) content.

3. The hard surface cleaning composition of claim 1 wherein said at least one low-volatile non-VOC evaporative organic solvent is a glycol ether having a formula—
R₁—O—R₂
wherein R₁ is a C₁-C₈ linear, branched or cyclic alkyl or alkenyl optionally substituted with —OH, —OCH₃, or —OCH₂CH₃ and R₂ is a C₁-C₆ linear, branched or cyclic alkyl or alkenyl substituted with —OH.

4. The hard surface cleaning composition of claim 2 wherein said at least one low-volatile non-VOC evaporative organic solvent is a glycol ether having a formula—
R₁—O—R₂
wherein R₁ is a C₁-C₈ linear, branched or cyclic alkyl or alkenyl optionally substituted with —OH, —OCH₃, or —OCH₂CH₃ and R₂ is a C₁-C₆ linear, branched or cyclic alkyl or alkenyl substituted with —OH.

5. The hard surface cleaning composition of claim 1 wherein said surfactant is amphoteric.

6. The hard surface cleaning composition of claim 2 wherein said surfactant is amphoteric.

7. The hard surface cleaning composition of claim 3 wherein said surfactant is amphoteric.

8. The hard surface cleaning composition of claim 4 wherein said surfactant is amphoteric.

9. The hard surface cleaning composition of claim 5 wherein said surfactant is disodium cocoamphodipropionate.

10. The hard surface cleaning composition of claim 6 wherein said surfactant is disodium cocoamphodipropionate.

11. The hard surface cleaning composition of claim 1 wherein said at least one low-volatile evaporative organic solvent is ethylene glycol n-hexyl ether.

12. The hard surface cleaning composition of claim 2 wherein said at least one low-volatile evaporative organic solvent is ethylene glycol n-hexyl ether.

13. The hard surface cleaning composition according to claim 9 wherein said at least one low-volatile non-VOC evaporative organic solvent is ethylene glycol n-hexyl ether.

14. The hard surface cleaning composition according to claim 10 wherein said at least one low-volatile non-VOC evaporative organic solvent is ethylene glycol n-hexyl ether.

15. The hard surface cleaning composition according to claim 1 wherein said at least one surfactant of (b) comprises an amphoteric surfactant and an anionic surfactant.

16. The hard surface cleaning composition according to claim 2 wherein said at least one surfactant of (b) comprises an amphoteric surfactant and an anionic surfactant.

17. The hard surface cleaning composition according to claim 3 wherein said at least one surfactant of (b) comprises an amphoteric surfactant and an anionic surfactant.

18. The hard surface cleaning composition according to claim 4 wherein said at least one surfactant of (b) comprises an amphoteric surfactant and an anionic surfactant.

19. The hard surface cleaning composition according to claim 15 wherein said amphoteric surfactant is disodium cocoamphodipropionate and said anionic surfactant is a sulfate and/or sulfonate compound.

20. The hard surface cleaning composition according to claim 16 wherein said amphoteric surfactant is disodium cocoamphodipropionate and said anionic surfactant is a sulfate and/or sulfonate compound.

21. The hard surface composition according to claim 19 wherein said at least one volatile evaporative organic solvent is ethylene glycol n-hexyl ether.

22. The hard surface composition according to claim 20 wherein said at least one volatile evaporative organic solvent is ethylene glycol n-hexyl ether.

23. The hard surface cleaning composition according to claim 1 wherein said composition has a pH of 2 or above.

24. The hard surface cleaning composition according to claim 2 wherein said composition has a pH of 2 or above.

25. The hard surface cleaning composition according to claim 1 wherein said composition has a pH of 2 to 13.

26. The hard surface cleaning composition according to claim 2 wherein said composition has a pH of 2 to 13.

27. The hard surface cleaning composition according to claim 1 wherein said at least one co-solvent of (c) is propylene glycol.

28. The hard surface cleaning composition according to claim 2 wherein said at least one co-solvent of (c) is propylene glycol.

29. The hard surface cleaning composition according to claim 3 wherein said at least one co-solvent of (c) is propylene glycol.

30. The hard surface cleaning composition according to claim 4 wherein said at least one co-solvent of (c) is propylene glycol.

31. The hard surface cleaning composition according to claim 5 wherein said at least one co-solvent of (c) is propylene glycol.

32. The hard surface cleaning composition according to claim 6 wherein said at least one co-solvent of (c) is propylene glycol.

33. The hard surface cleaning composition according to claim 7 wherein said at least one co-solvent of (c) is propylene glycol.

34. The hard surface cleaning composition according to claim 8 wherein said at least one co-solvent of (c) is propylene glycol.

35. The hard surface cleaning composition according to claim 9 wherein said at least one co-solvent of (c) is propylene glycol.

36. The hard surface cleaning composition according to claim 10 wherein said at least one co-solvent of (c) is propylene glycol.

37. The hard surface cleaning composition according to claim 1 wherein said at least one co-solvent of (c) is monoethanolamine.

38. The hard surface cleaning composition according to claim 2 wherein said at least one co-solvent of (c) is monoethanolamine.

39. The hard surface cleaning composition according to claim 3 wherein said at least one co-solvent of (c) is monoethanolamine.

40. The hard surface cleaning composition according to claim 4 wherein said at least one co-solvent of (c) is monoethanolamine.

41. The hard surface cleaning composition according to claim 5 wherein said at least one co-solvent of (c) is monoethanolamine.

42. The hard surface cleaning composition according to claim 6 wherein said at least one co-solvent of (c) is monoethanolamine.

43. The hard surface cleaning composition according to claim 7 wherein said at least one co-solvent of (c) is monoethanolamine.

44. The hard surface cleaning composition according to claim 8 wherein said at least one co-solvent of (c) is monoethanolamine.

45. The hard surface cleaning composition according to claim 9 wherein said at least one co-solvent of (c) is monoethanolamine.

46. The hard surface cleaning composition according to claim 10 wherein said at least one co-solvent of (c) is monoethanolamine.

47. The hard surface cleaning composition according to claim 25 wherein said at least one co-solvent of (c) further includes monoethanolamine.

48. The hard surface cleaning composition according to claim 26 wherein said at least one co-solvent of (c) further includes monoethanolamine.

49. The hard surface cleaning composition according to claim 1 wherein said at least one co-solvent of (c) is isopropanol.

50. The hard surface cleaning composition according to claim 2 wherein said at least one co-solvent of (c) is isopropanol.

51. The hard surface cleaning composition according to claim 3 wherein said at least one co-solvent of (c) is isopropanol.

52. The hard surface cleaning composition according to claim 4 wherein said at least one co-solvent of (c) is isopropanol.

53. The hard surface cleaning composition according to claim 5 wherein said at least one co-solvent of (c) is isopropanol.

54. The hard surface cleaning composition according to claim 6 wherein said at least one co-solvent of (c) is isopropanol.

55. The hard surface cleaning composition according to claim 15 wherein said at least one co-solvent of (c) is isopropanol.

56. The hard surface cleaning composition according to claim 16 wherein said at least one co-solvent of (c) is isopropanol.

57. The hard surface cleaning composition according to claim 19 wherein said at least one co-solvent of (c) is isopropanol.

58. The hard surface cleaning composition according to claim 20 wherein said at least one co-solvent of (c) is isopropanol.

59. The hard surface cleaning composition according to claim 1 further comprising a polymer or a copolymer.

60. The hard surface cleaning composition according to claim 59 wherein said polymer is an acrylic polymer.

61. The hard surface cleaning composition according to claim 59 wherein said copolymer is an acrylic copolymer.

62. A hard surface cleaning composition comprising
(a) greater than 0 to about 4% by wt. of at least one low-volatile and/or high-volatile evaporative organic solvent that has limited solubility in water of less than 20% and reduces surface tension of the composition to less than 40 dynes/cm;
(b) greater than 0 to about 5% by wt. of at least one surfactant which is amphoteric, anionic, nonionic, cationic or a mixture thereof;
(c) from 0 to about 30% by wt. of at least one co-solvent which is different from (a) and when said co-solvent is a low volatile non-VOC solvent, said co-solvent has at least a different water-solubility or different surface tension reduction capacity from said solvent of (a);
(d) a polymer or a copolymer; and
(e) a balance of an aqueous carrier;
wherein said composition has less than about 4% by wt. volatile organic compound (VOC) content.

63. A hard surface cleaning composition according to claim 62 wherein said polymer is an acrylic polymer.

64. A hard surface cleaning composition according to claim 62 wherein said copolymer is an acrylic copolymer.

65. A hard surface cleaning composition according to claim 62 wherein said solvent of (a) is a glycol ether, said at least one surfactant of (b) includes an amphoteric surfactant and an anionic surfactant, said at least one co-solvent of (c) includes an aliphatic alcohol, a glycol and an alkanolamine.
